(19) United States
(12) Patent Application Publication
(10) Pub. No.: US 2026/0153152 A1
(43) Pub. Date: Jun. 4, 2026

(54) Deep-Sea Valve

(71) Applicant: Robert Bosch GmbH, Stuttgart (DE)

(72) Inventor: Gottfried Hendrix, Gemuenden (DE)

(21) Appl. No.: 19/384,631

(22) Filed: Nov. 10, 2025

(30) Foreign Application Priority Data
Nov. 11, 2024 (DE) 10 2024 210 805.7

(51) Int. Cl. F16K 3/02; E21B 34/04

(52) U.S. Cl. CPC F16K 3/0254; E21B 34/04

(57) ABSTRACT

A deep-sea valve includes at least one valve slide. The at least one valve slide is displaceable by an actuator in order to open a flow passage in the deep-sea valve. A spring assembly is arranged on the deep-sea valve and configured to displace the valve slide to close the flow passage in an emergency. The actuator includes an electric drive and the actuator, and the spring assembly is arranged on opposite sides of the flow passage.

This application claims priority under 35 U.S.C. § 119 to application no. DE 10 2024 210 805.7, filed on Nov. 11, 2024 in Germany, the disclosure of which is incorporated herein by reference in its entirety.

### BACKGROUND

The disclosure relates to deep-sea valves and valve assemblies on subsea trees.

Subsea trees, also referred to as subsea Xmas trees, or subsea eruption crosses (hereinafter referred to as subsea tree), comprise valve assemblies as well as at least one flow pipe that is mountable vertically on a wellbore at the seabed. The subsea trees serve as an interface between the pipeline and the wellbore in the seabed. The valve assemblies comprise deep-sea valves for shutting off and regulating production flows as well as various maintenance functions during operation.

Subsea trees are used in the field of oil production or the storage of gases (e.g., CO₂ or hydrogen in the seabed). For each production field or storage field, a plurality of wellbores is used, and each wellbore comprises one subsea tree. Thus, for each production field or storage field, a large number of subsea trees are used, which may cause high costs, in particular, in the installation of the subsea trees.

Subsea trees are placed on the seabed at considerable expense. Using a crane on a ship or platform, the subsea trees are lowered vertically onto the wellbore in water depths of up to and exceeding 3,500 meters, and connected by a diving robot.

Typically, the (remotely operated) deep-sea valves of a subsea tree are actuated by a hydraulic cylinder unit with a return spring. The actuation takes place via a control block with switching valves and a hydraulic pressure accumulator, which are fastened on the subsea tree. The pressure supply is provided from platforms or ships through the water. In the event of a control failure, the valves are movable into a closed position by way of the springs for safety reasons.

Typically, the process valves are arranged on one side of the subsea tree. On such an operating side, emergency operations may also be carried out by way of a diving robot.

The hydraulic cylinders and springs require a relatively large installation space and have a large mass. In addition, the hydraulic valves with a control block and at least one hydraulic accumulator are also mounted on the subsea tree, which likewise may be of complex shape and executed with a large mass. The control block and the hydraulic accumulator are arranged on a side facing away from the operating side.

Proceeding from this, it is the object of the disclosure to at least partially solve the problems described with reference to the prior art. In particular, a possibility is to be created by which subsea trees may be transported and installed more easily. In particular, in order to simplify and make more cost-effective the installation of numerous subsea trees on the seabed, it is desirable for the subsea trees to be configured in a more compact and, where applicable, lighter manner. A particular focus lies on easier and more durable mounting on the wellbore on the seabed.

This object is achieved by the features set forth below. Further advantageous embodiments of the disclosure are specified in the description below. It is to be noted that features listed individually in the disclosure may be combined with one another in any technologically sensible manner, and define further embodiments of the disclosure. Moreover, the features specified below are further defined and explained in the description, wherein additional preferred embodiments of the disclosure are presented.

A deep-sea valve having at least one valve slide contributes to the achievement of this object. The at least one valve slide is displaceable by an actuator in order to (selectively) open or close a flow passage in the deep-sea valve. A spring assembly is likewise arranged on the deep-sea valve and configured to displace the valve slide in order to close the flow passage in an emergency (when the actuator is not available and/or automatically). The actuator comprises an electric drive. The actuator and the spring assembly are arranged on opposite sides of the flow passage.

Preferably, the deep-sea valve is usable for operation under water. In particular, the deep-sea valve may be used at depths of at least 1,000 meters, preferably at least 3,000 meters, and possibly more than 3,500 meters. The deep-sea valve may be used on a wellbore for the production of, for example, crude oil. It is also usable at a wellbore for a storage site, for example, for CO₂ [carbon dioxide]. The deep-sea valve may be used to regulate an inflow or outflow at the wellbore and, in particular, to open and/or close it. Maintenance functions may likewise be enabled by way of the deep-sea valve.

Preferably, the valve slide is a flat slide. Preferably, the valve slide may comprise an opening and a closure. The valve slide may be displaced axially such that the opening partially or completely releases an inflow or outflow (flow passage) at the wellbore. It is possible that the valve slide is displaced such that the closure completely blocks the flow passage at the wellbore.

The valve slide is displaceable by an actuator. The actuator may displace the valve slide transversely to the wellbore. The actuator may be fixedly or detachably connected to the deep-sea valve. It is possible that the actuator directly actuates the valve slide. Preferably, the actuator is arranged such that it has a travel direction lying on a displacement axis that coincides with the direction of displacement of the valve slide. In particular, it is possible that the actuator displaces the valve slide without deflection or gearing.

It is provided that the deep-sea valve has at least one flow passage that is closable by the valve slide. The flow passage may be a pipe section within the deep-sea valve. Preferably, the flow passage is cylindrical. The flow passage may be connected to the wellbore. It is possible that the wellbore and the flow passage lie on a common axis. It is possible that the wellbore and the flow passage have axes that run parallel to one another in an offset manner. Preferably, the axis of the deep-sea valve passes through the center of the flow passage and transversely to the displacement axis. In particular, the axis and the flow passage may form a flow axis of the deep-sea valve.

It is possible that the spring assembly comprises at least one spring. Preferably, the spring assembly comprises one, two, three, four, five, or a plurality of springs. Preferably, the spring assembly is configured to have a constant (unidirectional) spring force. In particular, the valve slide may be displaced by the spring assembly (in the same or in the opposite direction as by the actuator). It is possible that the spring force of the spring assembly is configured such that the flow passage is closable in an emergency, that is, in particular, when the actuator is not active. It is possible that the spring force is sufficiently high for the flow passage to be closable even under high pressure.

It is possible that the springs of the spring assembly are arranged in a sleeve that is fastened to the deep-sea valve. The springs may be supported at a first end against a stop of the sleeve, and may exert the spring force on the valve slide with another end.

Preferably, the electric drive is arranged in the actuator. In particular, the actuator may comprise an (own or encased) electric motor. The electric motor may have an internal power source arranged in the actuator. It is possible that the internal power source is a battery. It is possible that the actuator is supplied with power via a power cable and has no internal power source. It is possible that the power cable is connected to a power source on a platform or a ship at the water surface.

The actuator and the spring assembly are arranged on (diametrically) opposite sides of the flow passage. It is possible that the actuator and the spring assembly each exert an opposing force along the common displacement axis.

It is possible that the spring assembly and the actuator are connected or connectable via a shaft. The valve slide may be arranged on the shaft. It is possible that the shaft has respective shaft sections that lie on a common displacement axis and are fastened to the valve on opposite sides. The shaft sections may each have a free end. It is possible that the actuator is connected or connectable to the free end of one shaft section. It is possible that the spring assembly is connected or connectable to the free end of the other shaft section. Preferably, the spring assembly is fixedly connected to the free end of one shaft section. It is possible that the safety function is constantly ensured and that the valve slide is always displaceable in an emergency in such a way that the flow passage is closed. Preferably, the other free end is replaceably connected to the actuator. It is possible that the actuator may be connected or disconnected while the deep-sea valve is installed or in operation.

The spring assembly may comprises at least one spring that counteracts a thrust force of the actuator (for opening the flow passage). It is possible that the actuator exerts a thrust force on the valve slide in order to displace it in such a way that the flow passage is opened and, if applicable, also closed. The thrust force of the actuator may act against the spring force of the spring assembly. It is possible that a constant thrust force of the actuator is exerted on the valve slide for opening or holding open the flow passage, which acts in opposition to the spring force of the spring assembly. It is possible that, in the event of a power failure or an emergency, the valve slide is pushed back by the spring force of the spring assembly and closes the flow passage. It is possible that, in this way, a safety closure is ensured, which makes it possible to safely close the flow passage and thus the wellbore at any time.

The spring assembly and the actuator may be arranged in such a way that the deep-sea valve is in balance along the flow axis of the deep-sea valve. It is possible that the displacement axis and the flow axis intersect at the center of the flow passage. It is possible that the deep-sea valve is configured in such a way that it is in balance such that it has no tilting moment transverse to the flow axis. In other words, the center of gravity of the deep-sea valve lies (approximately) at the center of the flow passage.

The actuator may be connected to the deep-sea valve via an interface and be replaceable/couplable. It is possible to provide the interface for a standardized actuator. It is possible that the actuator is replaceable during operation. In particular, it is possible that the actuator is replaceable in the event of a malfunction. It is possible that the deep-sea valve is held in a closed position by the spring force of the spring assembly upon replacement of the actuator. Thus, the actuator may be replaced without the flow passage being open. It is possible that the deep-sea valve may only be opened when the actuator is connected and functional.

To achieve this object, a valve assembly in a subsea tree having a flow pipe and a plurality of the described deep-sea valves is provided. The deep-sea valves may be arranged at different positions on the valve assembly.

Preferably, subsea trees are placed on the wellbore and comprise at least one flow pipe that is directly connectable to the wellbore. Thus, the subsea tree may serve as a connection for additional pipes in order to discharge liquids and/or gases from the wellbore or to introduce them into it. It is possible that the subsea tree comprises, in the at least one flow pipe, at least one of the described deep-sea valves, such that the flow may be stopped and/or opened and, in particular, regulated. It is also possible to provide, in the subsea tree, additional decentralized flow pipes with deep-sea valves in parallel to a central flow pipe and the deep-sea valves arranged therein. It is possible that these additional deep-sea valves are used for maintenance functions or further regulation of the flow through the flow pipe. It is possible that the entire valve assembly is placed in the subsea tree, such that all valves are placeable in one component on the wellbore.

The plurality of deep-sea valves may be arranged in the subsea tree offset along different axes, such that the subsea tree is balanced along a central axis of the flow pipe. The central axis of the flow pipe runs through the center of the flow pipe. It is possible that the subsea tree may be movable by a crane and placed above the wellbore. Preferably, the subsea tree is configured in such a way that it may be lowered vertically above the wellbore when it is held laterally on the flow pipe. Preferably, the subsea tree may be fastened to the wellbore without a tilting moment acting transverse to the flow pipe.

It is possible that the valve assembly comprises a control block. The control block may have at least one control unit by way of which each actuator is actuatable. It is possible that all actuators of the deep-sea valves of the valve assembly are connected to the control block. The control block may additionally comprise manual actuation options, such that the actuators are manually actuatable. It is possible that the control unit is a central power supply for all actuators. All actuators may be individually controlled by the control unit. Preferably, the control block is fastened to the actuators. It is possible that the control block is also directly connected to the subsea tree. Preferably, the control block is fastened in such a way that the subsea tree is balanced along the central axis of the flow pipe.

In particular, the deep-sea valve provides advantages or alleviation with respect to the problems mentioned at the outset. The particular advantages and design features described for the deep-sea valve are applicable and transferable to the described valve assembly, and vice versa.

### BRIEF DESCRIPTION OF THE DRAWINGS

The disclosure and the technical environment are explained in more detail below with reference to two figures. The illustrations are schematic and are not intended to depict size relationships. The explanations provided with reference to individual details of the figure are extractable and freely combinable with aspects from the foregoing description, unless something different necessarily results for a person skilled in the art, or such a combination is explicitly excluded. Shown schematically are:

FIG. 1: Subsea tree with valve assembly; and

FIG. 2: Deep-sea valve in the subsea tree.

### DETAILED DESCRIPTION

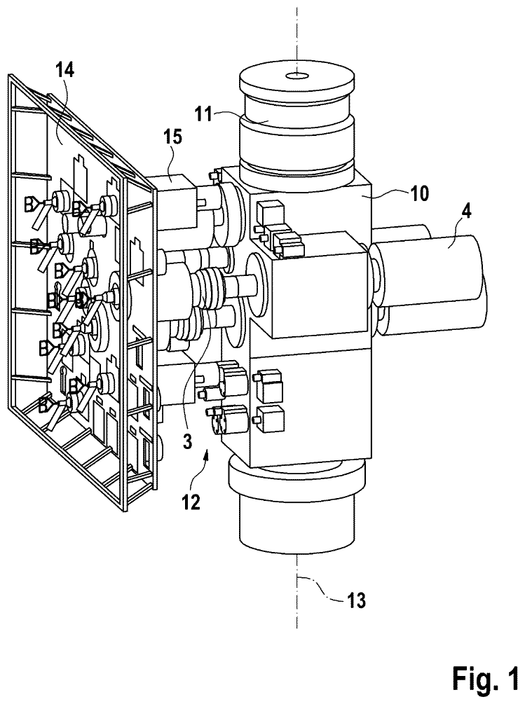

FIG. 1 shows a subsea tree 10. The subsea tree 10 comprises a valve assembly 12 having a plurality of actuators 3 and spring assemblies 4. The actuators 3 are connected to a control block 14, which comprises a respective control unit 15 for each actuator 3. The subsea tree comprises a flow pipe 11 that has a central axis 13. The actuators 3 are mounted with the control block 14 on a side of the subsea tree 10 opposite the spring assemblies 4. In particular, the spring assemblies 4 and the actuators 3 are arranged on the subsea tree 10 in such a way that it is balanced along the central axis of the flow pipe 13. The subsea tree 10 has no tilting moment acting transverse to the central axis of the flow pipe 13.

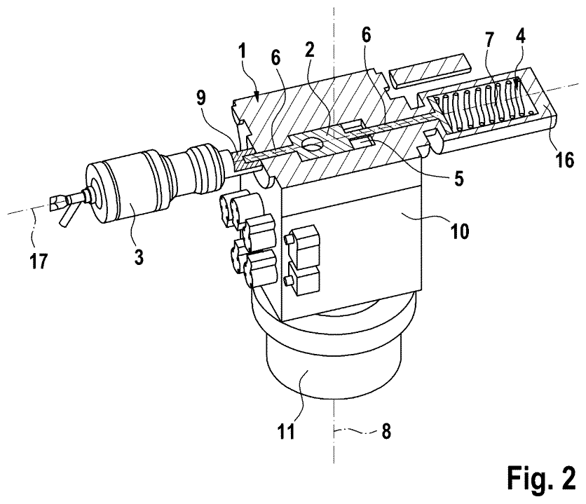

FIG. 2 shows a sectional view of a deep-sea valve 1 in the subsea tree 10. The deep-sea valve 1 comprises the actuator 3, a spring assembly 4, and a valve slide 2. The valve slide 2 is connected by a shaft 6 to the actuator 3 and to the spring assembly 4, respectively. The spring assembly 4 comprises a spring 7 that acts on the shaft 6 and thus on the valve slide 2. The springs 7 of the spring assembly 4 are arranged in a sleeve 16. The springs 7 are supported at a first end against a stop of the sleeve 16 and exert a spring force on the shaft 6 of the valve slide 2 with another end. The actuator 3 is connectable to the subsea tree 10 at an interface 9. The valve slide 2 is displaceable, such that it may open and close a flow passage 5. The valve slide 2 is displaceable along a displacement axis 17, on which the actuator 3 and the spring assembly 4 are also arranged. Furthermore, the flow passage 5 has a flow axis 8. The flow axis 8 may be offset relative to the central axis of the flow pipe 13. The actuator 3 and the spring assembly 4 are arranged in such a way that the deep-sea valve 1 is balanced along the flow axis 8.

With the solution proposed here, the problems described with reference to the prior art may be at least partially alleviated. In particular, solutions have been presented by way of which a lighter and more compact subsea tree with an improved deep-sea valve is proposed.

### REFERENCE SIGNS

1 Deep-sea valve
2 Valve slide
3 Actuator
4 Spring assembly
5 Flow passage
6 Shaft
7 Spring
8 Flow axis
9 Interface
10 Subsea tree
11 Flow pipe
12 Valve assembly
13 Central axis of the flow pipe
14 Control block
15 Control unit
16 Sleeve
17 Displacement axis

What is claimed is:

1. A deep-sea valve, comprising:
at least one valve slide;
an actuator including an electric drive; and
a spring assembly,
wherein the at least one valve slide is displaceable by the actuator in order to open a flow passage in the deep-sea valve,
wherein the spring assembly is arranged and configured to displace the at least one valve slide to close the flow passage in an emergency, and
wherein the actuator and the spring assembly are arranged on opposite sides of the flow passage.

2. The deep-sea valve according to claim 1, wherein:
the spring assembly and the actuator are connectable or connected by a shaft, and
the at least one valve slide is arranged on the shaft.

3. The deep-sea valve according to claim 1, wherein the spring assembly includes at least one spring that is configured to counteract a thrust force of the actuator.

4. The deep-sea valve according to claim 1, wherein the spring assembly and the actuator are arranged in such a way that the deep-sea valve is balanced along a flow axis.

5. The deep-sea valve according to claim 1, wherein the actuator is connected to the at least one valve slide via an interface, and is replaceable.

6. A subsea tree having at least one flow pipe and a valve assembly, and comprising a plurality of deep-sea valves according to claim 1.

7. The subsea tree according to claim 6, wherein the plurality of deep-sea valves are arranged in the subsea tree offset along different axes such that the subsea tree is balanced along a central axis of the flow pipe.

8. The subsea tree according to claim 6, further comprising a control block, wherein the control block includes at least one control unit by way of which each actuator is actuatable.
